(19) United States
(12) Patent Application Publication
(10) Pub. No.: US 2006/0064931 A1
(43) Pub. Date: Mar. 30, 2006

(54) Method for generation of a synthesis gas mixture co-h</sb> under pressure by catalytic partial oxidation with minimisation of the formation of soot

(76) Inventors: Daniel Gary, Montigny le Bretonneux (FR); David Meneses, Issy-les-Moulineaux (FR); Clotilde Muller, Antony (FR)

Correspondence Address: AIR LIQUIDE, 2700 POST OAK BOULEVARD, SUITE 1800, HOUSTON, TX, 77056, US

(21) Appl. No.: 10/539,909

(22) PCT Filed: Dec. 15, 2003
(86) PCT No.: PCT/FR03/50168

§ 371 Date: Jun. 16, 2005

(30) Foreign Application Priority Data
Dec. 17, 2002 (FR) 02/16015

(51) Int. Cl. C01B 3/24

(52) U.S. Cl. 48/198.1; 423/650

(57) ABSTRACT

Method and apparatus for creating a gaseous mixture containing controlled amounts of hydrogen and carbon monoxide. Hydrogen and carbon monoxide are produced through partial catalytic oxidation reactions between hydrocarbons and oxygen. The oxidation takes place in a reactor at a temperature of less than 1200° C. and at a pressure between 3 bar and 20 bar. A gas mixture of hydrogen and some carbon monoxide is then recovered from the oxidation. This mixture is transferred to a cooling chamber where it is cooled, by direct contact with pressurized water, to a temperature between −20° C. and 80° C. The cooled gas is also at a pressure between 3 bar and 20 bar. The cooling chamber and the reactor are both located in the same vessel, such that the gas transport time between the two is less than 50 milliseconds.

The present invention relates to the field of methods for producing a gas mixture containing at least hydrogen (H₂) and carbon monoxide (CO) from at least one hydrocarbon, in which a partial catalytic oxidation of at least one hydrocarbon is carried out in the presence of oxygen or of a gas comprising oxygen, to produce a mixture of hydrogen and carbon monoxide.

Hydrogen is a widely used gas, particularly in the chemistry field.

Thus, the total annual production of hydrogen is about 50 billion m³ of which 95% is used in refining, in petrochemicals, for the synthesis of methanol (MeOH) or for the production of ammonia (NH₃).

Marketable hydrogen, that is, noncaptive production, hence only accounts for a few percent of this total production.

In fact, owing to the growing need for marketable hydrogen, growing at a rate of about 10% per year, and the future needs felt in the industry in general, particularly in chemicals, petrochemical metallurgy, electronics, fine chemicals, in decentralized energy production, clean and nonpolluting transport, using fuel cells, and owing to the problems raised by the distribution infrastructure for this product, in particular its transport, storage and related safety problems, it is appearing increasingly necessary to have production sources directly on site.

Hydrogen is produced in large quantities chiefly at refineries and major chemical plants, by various known methods, that is:

steam reforming of hydrocarbons of petroleum origin (naphtha) or of natural gas. This is a highly endothermic reaction, carried out at between 800° C. and 900° C. with one or more catalysts, and at high pressure, for example, at about 15 bar to 35 bar. The burners are located outside the catalyst beds and the hydrocarbon/steam mixture is preheated by heat exchangers that use the hot combustion gases. This method can be used to achieve H₂/CO production ratios of between 3 and 4 depending on the steam flow rate.

mixed reforming: this is an autothermal method in which the heat energy necessary for steam reforming on a catalyst is, for example, provided by the partial combustion of CH₄ to CO₂ and H₂O. By contrast, the H₂/CO ratio is lower than in production by steam reforming, that is, about 2.2 to 2.5.

partial oxidation of hydrocarbons. This method does not require any catalyst. The reaction is carried out at between 1300° C. and 1400° C. with little or no steam. This method is exothermic but produces less hydrogen than the preceding methods. This is why it is necessary to promote the hydrogen production reaction to the maximum by CO conversion in the presence of steam and on a catalyst, according to the reaction (1) below (referred to as the “water gas reaction”):
CO+H₂O→CO₂+H₂ (1)

Accordingly, for the exclusive production of hydrogen, steam reforming is the best method today, particularly when it is associated with the water gas conversion reaction and with a PSA (Pressure Swing Adsorption) method to purify the hydrogen thus produced.

The energy efficiency of such a method is excellent, that is, up to 85% for large installations, by utilizing the unavoidable steam.

Besides the specific production units, marketable hydrogen is also derived from other sources, that is:

recovery of hydrogen produced in chemical and refining dehydrogenation operations, for example, reforming and catalytic cracking;

diversion of a portion of the hydrogen produced at captive producers when it is in excess. However, this source is tending to shrink because of the growing needs for hydrogen, on the one hand, for feedstock desulfurization to meet the environmental standards that are being set up, and also, for the hydrogenation treatment of increasingly heavy feedstocks.

coke production in steel plants.

electrolysis of sodium chloride (NaCl) in which hydrogen is coproduced at the same time as Cl₂.

Small hydrogen production units also exist, employing the decomposition of compounds rich in hydrogen atoms, particularly by thermal cracking of NH₃, by catalytic reforming of CH₃OH or by electrolytic dissociation of H₂₀.

However, the production of hydrogen from ammonia or methanol always entails logistics of delivery of these liquid products.

Moreover, ammonia (NH₃) is a pollutant that is harmful to the environment (toxicity, odor, etc.), and the regulations on this product are becoming increasingly stringent.

Furthermore, the purchase price of these products is subject to wide fluctuations that tend to penalize the overall profitability of the methods, particularly in the case of methanol.

Besides, hydrogen production by electrolysis consumes a considerable amount of energy (about 5 KWh/Sm³ of hydrogen produced) and in countries where the price of electricity is high, this solution is unsuitable for production capacities above about 50 Sm³/h.

These various hydrogen production methods hence present numerous drawbacks, and no current production method can be considered as fully satisfactory from the industrial standpoint.

In previous researches, the applicant wished to propose an improved hydrogen production method in comparison with known methods, that is, offering easy maintenance and application, low investment, that uses natural gas or LPG to produce the hydrogen, and which requires few utilities such as water, steam, etc.

In other words, these previous researches (as described in document WO 01/62662) were aimed at proposing a method for producing hydrogen gas:

that consumes little energy to maintain the hydrogen production reaction, that is, if possible, employing an autothermal reaction;

having a sufficient hydrocarbon-to-hydrogen conversion yield;

that is compact, requires low investment, and is simple to maintain and apply,

that allows automatic startup and completely safe operation, preferably without on site personnel;

allowing the use of an inexpensive primary source of hydrocarbons;

that is adapted to medium-scale production, that is, of 50 Sm³/h to 300 Sm³/h.

The solution provided by this prior work can accordingly be summarized as follows: a method for preparing a gaseous atmosphere, having controlled hydrogen and carbon monoxide contents, from at least one light hydrocarbon selected from the group of C1 to C4 compounds such as natural gas, methane, ethane or a mixture of methane and ethane, or a mixture of butane and propane, in which:

(a) a partial catalytic oxidation of at least one hydrocarbon is carried out at a temperature below 1200° C., a pressure of 3 to 20 bar and in the presence of oxygen or of a gas comprising oxygen, to produce hydrogen (H₂) and carbon monoxide (CO);

(b) a gas mixture is recovered, comprising at least hydrogen (H₂) and carbon monoxide (CO);

(c) the gas mixture obtained in step (b) is subjected to instantaneous (sudden) cooling to a temperature of between −20° C. and +80° C.;

(d) the gas mixture obtained in step (c) is subjected to a separation in order to produce a hydrogen-rich gas stream;

and in which, in step (b) and/or in step (c), a gas mixture is obtained at a pressure of 3 to 20 bar.

In this method, only the hydrogen fraction is utilized. However, the waste is eliminated, for example by combustion in a flare.

Also worth noting is the work of the applicant as reported in the later document FR 0116581 filed on Dec. 20, 2001, concerning the installation, at the head of the reactor, of a new arrangement allowing a homogenous premixture of the input reactants to be prepared in complete safety.

It then appeared that these previous results of the applicant needed to be further improved, particularly as to the question of cooling (quenching) of the synthesis gas thus produced, and the induced risks of soot formation, to propose a more compact and thus improved technology, able to produce a synthesis gas substantially at ambient temperature.

The technical solution proposed according to the present invention accordingly consists in carrying out the partial oxidation reaction and the quenching of the gas produced (in this case a direct water quench) in one and the same vessel, by providing a gas transport time between the two zones (reaction zone and quench zone) that is extremely short, i.e. shorter than a few tens of milliseconds, typically shorter than 50 ms. This rapid quench (which can be considered as instantaneous or virtually instantaneous) makes it possible to fix the composition of the gas instantaneously and to limit the Boudouard reaction (2CO→C+CO₂) and hence the generation of soot that is harmful to the process. Moreover, the sheet metal of the reactor that is placed in contact with this corrosive atmosphere is no longer exposed in the critical temperature range (750° C.-450° C.), propitious to its degradation due to the mechanism well known in the literature called “metal dusting”.

The invention accordingly relates to a method for preparing a gaseous atmosphere having controlled hydrogen and carbon monoxide contents, in which:

(a) a partial catalytic oxidation of at least one hydrocarbon is carried out at a temperature below 1200° C., a pressure of 3 to 20 bar and in the presence of oxygen or of a gas comprising oxygen, to produce hydrogen (H₂) and carbon monoxide (CO);

(b) a gas mixture is recovered, comprising at least hydrogen (H₂) and carbon monoxide (CO);

(c) the gas mixture obtained in step (b) is subjected to cooling by direct contact with pressurized water, to a temperature of between −20° C. and +80° C.;

and in which, in step (b) and/or in step (c), a gas mixture is obtained at a pressure of 3 to 20 bar;
and is characterized in that said catalytic oxidation reaction and the cooling step (c) are carried out in one and the same vessel, providing a gas transport time between the two zones of catalytic reaction and cooling that is shorter than a few tens of milliseconds, and preferably shorter than 50 ms.

The method according to the invention can also adopt one or a plurality of the following technical characteristics:

the gas mixture obtained from step (c) is subjected to a separation step (d) to produce a hydrogen-rich gas stream;

in step (c), the cooling is carried out by passage of the mixture to be cooled in a shower of pressurized water;

the hydrocarbon is selected from the group of light hydrocarbons (C1-C4) formed by natural gas, methane, ethane or a mixture of methane and ethane, or a mixture of butane and propane;

the hydrocarbon is methane or natural gas, the CH₄/O₂ volumetric flow rate ratio being preferably between 1.2 and 2.1;

the gas mixture obtained in step (b) and/or in step (c) is at a pressure of 4 to 20 bar.

step (a) is carried out at a pressure of 6 to 12 bar;

the gas comprising oxygen is a gas mixture comprising nitrogen and oxygen, preferably air;

the catalyst is formed from at least one metal deposited on an inert support, the metal preferably being nickel, rhodium, platinum and/or palladium, or an alloy containing at least one of these metals;

the gas mixture obtained in step (b) contains approximately 30 to 40% (by volume) of hydrogen, 15 to 20% of CO, and the rest is nitrogen and possibly traces of CO₂, H₂O or other unavoidable impurities such as CnHm waste, and preferably the gas mixture obtained in step (b) contains approximately 31 to 34% (by volume) of hydrogen, 17 to 19% of CO and the rest is nitrogen and possibly traces of CO₂, H₂O or other unavoidable impurities such as CnHm waste;

step (a) is carried out at a temperature of between 600° C. and 1090° C., and preferably between 850 and 1000° C.;

in step (d), the separation serves to produce a hydrogen-rich gas stream containing at least 80% of hydrogen, preferably 99.9% to 99.99999% by volume of hydrogen;

the separation carried out in step (d) is carried out by means of a PSA method, of a TSA method or of a membrane permeation separation using one or more membrane modules, generating, on the one hand, said hydrogen-rich gas stream and, on the other, a waste-gas stream, the waste-gas stream being advantageously sent to a cogeneration unit, to generate electricity, preferably to a boiler;

the method comprises the supplementary step of:

(e) subjecting the gas mixture obtained in step (b) to a separation in order to remove at least a portion of the carbon dioxide and/or steam impurities that may be present, and thereby to produce a gaseous atmosphere having controlled contents of hydrogen, carbon monoxide and nitrogen;

the separation carried out in step (d) is carried out by means of a PSA method or a TSA method employing at least two adsorbers operating alternately, at least one of the adsorbers being in a regeneration phase while at least another of the adsorbers is in a phase of production of said hydrogen-rich gas stream;

the separation carried out in step (d) is carried out by membrane permeation using one or more membrane modules generating, on the one hand, said hydrogen-rich gas stream and, on the other, a waste-gas stream mainly containing nitrogen and carbon monoxide, and possibly residual hydrogen;

means are available for accelerating the gas mixture obtained at the reactor outlet between said two zones of reaction and cooling.

The invention further relates to an installation for preparing a gaseous atmosphere having controlled hydrogen and carbon monoxide contents, comprising:

a partial catalytic oxidation reactor suitable for oxidizing at least one hydrocarbon, at a temperature below 1200° C., a pressure of 3 to 20 bar and in the presence of oxygen or of a gas comprising oxygen, to produce hydrogen (H₂) and carbon monoxide (CO);

means for cooling the gas mixture obtained at the outlet of said reactor, by direct contact with pressurized water, to a temperature of between −20° C. and +80° C.;

and characterized in that said reactor and said cooling means are located in one and the same vessel, so as to have a gas transport time between the two zones of catalytic reaction and cooling that is shorter than a few tens of milliseconds, and preferably shorter than 50 ms.

Preferably, said cooling means comprise a shower of water into which the mixture to be cooled is sent.

According to one of the embodiments of the invention, the installation comprises a deflector system, located downstream of the cooling means, suitable for separating the drops of water in order to prevent them from being entrained by the cooled gas.

According to one of the advantageous embodiments of the invention, the installation comprises a device for supplying and recirculating pressurized cooling water, preferably equipped with a pressurized cooling water filtration system.

According to another of the advantageous embodiments of the invention, the installation comprises an inverted cone system located between the two zones of catalytic reaction and of cooling, suitable for permitting the acceleration of the gas mixture obtained at the reactor outlet between said two zones of reaction and of cooling.

It can accordingly be understood that the advantages of such an arrangement are in particular the following:

the gas composition is fixed almost immediately: it cannot deteriorate because the method is under thermodynamic control (this degradation would be observed during a slow lowering of the temperature in which the thermodynamics of the system causes the composition of the synthesis gas produced to change negatively).

the risk of soot formation is eliminated: in a few seconds (preferably in less than two seconds according to the present invention), the gas temperature falls below 450° C., and the so-called Boudouard reaction cannot take place.

In this area of search for compactness, reference may also be made to the work of the company Praxair as reported in document EP-931 842 which relates to a reactor for the production of a CO/H₂ atmosphere carried out substantially at atmospheric pressure for the heat treatment of metals by catalytic oxidation on noble metal, with quenching of the mixture produced by gas/gas heat exchange (exchange between the hot gas produced and the reagents entering the tubular systems located in one and the same vessel), the author being concerned here rather to achieve a short travel time of the input reagents between the exchanger which served to preheat them and their entry into the catalytic reactor, in order to limit the heat losses, as well as the risks of premature reactions between the input reagents before they enter into contact with the catalyst.

The invention will be better understood from a reading of the description that follows, with reference to the figures appended hereto as follows:

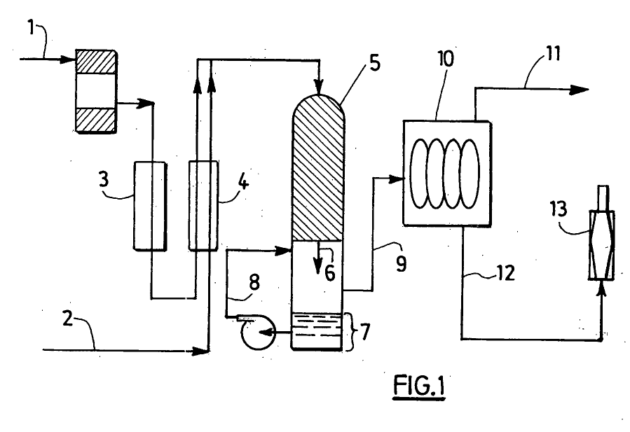

FIG. 1 shows a cross section of a hydrogen production installation according to the previous researches of the applicant;

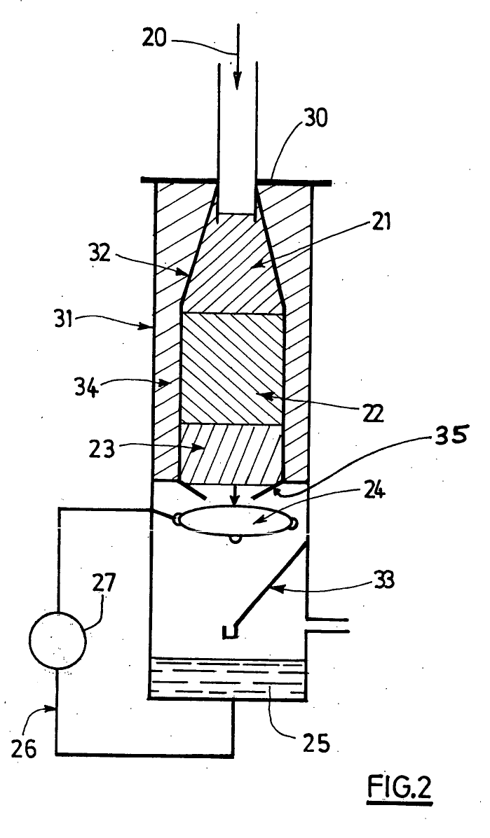

FIG. 2 shows a cross section of an installation for putting the present invention into practice.

FIG. 1 shows a catalytic reactor 5, supplied with air 1 (preheated in a heater 3) and with natural gas 2, the mixture being prepared in the mixer 4.

The partial catalytic oxidation (5) takes place at a temperature below 1200° C., a pressure of 3 to 20 bar, and a gas mixture containing hydrogen (H₂) and carbon monoxide (CO) is recovered at 6.

This gas mixture is subjected at 7 to a water quench to a temperature of between −20° C. and +80° C. The cooling water recycle system is denoted 8.

The mixture thus cooled is then subjected at 10 to a separation step of the “PSA” type, in order to produce at 11 a hydrogen-rich gas stream at a pressure of between 3 and 20 bar.

It may be observed that the waste 12, on the other hand, is eliminated in a flare 13.

In FIG. 2, showing an installation according to the invention, the mixture 20 of hydrocarbon and oxidizing gas, in the embodiment shown here, encounters in succession, within a refractory enclosure 32, a zone of inert beads 21, a catalyst zone 22, then another inert zone 23.

At the outlet of the catalytic reactor, the mixture that is obtained (comprising hydrogen and CO) immediately enters a cooling zone consisting here of a water shower (spray) 24.

This figure clearly depicts the fact that the reactor 32 and the cooling means are located in one and the same vessel 31 (metal enclosure) in order to provide a very short gas transport time between the two zones of catalytic reaction and of cooling, in this case shorter than a few tens of milliseconds.

The reactor here is insulated by the presence of a thermally insulating material 34.

Observable in this figure is the presence of three particularly advantageous elements characterizing embodiments of the invention:

the deflector system 33, located downstream of the cooling means, and suitable for separating the drops of water in order to prevent them from being entrained by the cooled gas;

an inverted cone system 35 which very advantageously serves to further reduce the gas transport time between the reactor and the cooling zone: by its being positioned between the catalytic reactor and the cooling means, it allows on the one hand, the acceleration of the gas mixture produced, and, on the other, its injection substantially at the centre of the cooling means (the water shower) for improved efficiency, and, finally, by thus limiting the contact between this hot gas and the metal of the external enclosure;

a loop (26, 27) for supplying and recirculating the pressurized cooling water between the bottom of the vessel and the shower means. This loop is also advantageously equipped with a filtration system suitable for trapping any particles of soot and/or of catalyst fines issuing from the method.

1-25. (canceled)

26. A method which may be used for creating a mixture of hydrogen and carbon monoxide, said method comprising:
a) producing hydrogen and carbon monoxide through a partial catalytic oxidation of at least one hydrocarbon with oxygen or a gas comprising oxygen, wherein said oxidation takes place:
1) at a temperature less than about 1200° C.;
2) at pressure between about 3 bar and about 20 bar; and
3) in a first zone of a vessel;
b) recovering a gas mixture from said partial oxidation, wherein:
1) said gas mixture comprises hydrogen and carbon monoxide;
2) said recovered gas mixture has a pressure between about 3 bar and about 20 bar; and
3) said gas mixture rapidly enters a second zone of said vessel in less than about 100 milliseconds; and
c) cooling said gas mixture by direct contact with pressurized water, wherein said gas mixture is cooled:
1) in said second zone of said vessel; and
2) to a temperature between about −20° C. and about 80° C.

27. The method of claim 26, wherein said cooled gas mixture has a pressure between about 3 bar and about 20 bar.

28. The method of claim 26, wherein said gas mixture rapidly enters said second zone of said vessel in less than about 50 milliseconds.

29. The method of claim 26, further comprising separating said cooled gas mixture to produce a hydrogen-rich gas stream.

30. The method of claim 26, wherein said cooling comprises passing said gas mixture through a shower of pressurized water.

31. The method of claim 26, wherein said hydrocarbon comprises at least one member selected from the group consisting of:
a) natural gas;
b) methane;
c) ethane;
d) a butane/propane mixture; and
e) mixtures thereof.

32. The method of claim 26, wherein:
a) said hydrocarbon comprises methane or natural gas; and
b) the CH₄/O₂ volumetric flow rate ratio is between about 1.2 and about 2.1.

33. The method of claim 26, wherein said recovered gas mixture has a pressure between about 4 bar and about 20 bar.

34. The method of claim 26, wherein said cooled gas mixture has a pressure between about 4 bar and about 20 bar.

35. The method of claim 26, wherein oxidation takes place at a pressure between about 6 bar and about 12 bar.

36. The method of claim 26, wherein said gas comprising oxygen further comprises nitrogen.

37. The method of claim 36, wherein said gas comprising oxygen is air.

38. The method of claim 26, wherein:
a) a catalyst for said partial catalytic oxidation is formed by placing at least one metal on an inert support; and
b) said metal comprises at least one member selected from the group consisting of:
1) nickel;
2) rhodium;
3) platinum;
4) palladium; and
5) alloys thereof.

39. The method of claim 26, wherein said recovered gas comprises:
a) hydrogen in an amount between about 30% to about 40% by volume;
b) carbon monoxide in an amount between about 15% to about 20% by volume;
c) trace impurities, wherein said trace impurities comprise at least one member selected from the group consisting of:
1) carbon dioxide;
2) water; and
3) CₙHₘ type waste impurities; and
4) mixtures thereof; and
d) nitrogen in an amount to account for the balance of the volume.

40. The method of claim 39, wherein said recovered gas comprises:
a) hydrogen in an amount between about 31% to about 34% by volume; and
b) carbon monoxide in an amount between about 17% to about 19% by volume.

41. The method of claim 26, wherein said oxidation takes place at temperature between about 600° C. and about 1090° C.

42. The method of claim 41, wherein said oxidation takes place at a temperature between about 850° C. and about 1000° C.

43. The method of claim 29, wherein hydrogen-rich gas stream comprises at least about 80% hydrogen by volume.

44. The method of claim 43, wherein said hydrogen-rich gas stream comprises about 99.9% to about 99.99999% hydrogen by volume.

45. The method of claim 29, wherein:
a) said cooled gas mixture is separated by a separation method;
b) said separation method comprises at least one member selected from the group consisting of;
1) a PSA separation method;
2) a TSA separation method; and
3) a membrane permeation separation method that uses at least one membrane module; and
c) said separation generates:
1) said hydrogen-rich gas stream; and
2) a waste gas stream.

46. The method of claim 45, further comprising generating electricity by sending said waste gas stream to a cogeneration unit.

47. The method of claim 46, wherein said waste gas stream is sent to a boiler.

48. The method of claim 26, further comprising removing at least part of the carbon dioxide and steam impurities from said gas mixture in order to produce a gas mixture with controlled amounts of hydrogen, carbon monoxide and nitrogen.

49. The method of claim 45, wherein:
a) said separation method comprises a PSA separation method;
b) said PSA separation method comprises operating at least two adsorbers, wherein said adsorbers operate alternately; and
c) when at least one said adsorber is in a regeneration phase, at least another said adsorber is in a hydrogen-rich gas stream production phase.

50. The method of claim 45, wherein:
a) said separation method comprises a TSA separation method;
b) said TSA separation method comprises operating at least two adsorbers, wherein said adsorbers operate alternately; and
c) when at least one said adsorber is in a regeneration phase, at least another said adsorber is in a hydrogen-rich gas stream production phase.

51. The method of claim 45, wherein:
a) said separation method comprises a membrane permeation separation method that uses at least one membrane module; and
b) said modules produce:
1) said hydrogen-rich gas stream; and
2) a waste gas stream, wherein said waste gas stream comprises:
i) nitrogen; and
ii) carbon monoxide.

52. The method of claim 51, wherein said waste gas stream further comprises hydrogen.

53. The method of claim 30, wherein said cooled gas mixture is substantially free of soot.

54. The method of claim 30, further comprising accelerating said gas mixture's passage between said first zone and said second zone with an accelerating means.

55. An apparatus which may be used for preparing a gas mixture with controlled parts of hydrogen and carbon monoxide, said apparatus comprising:
a) a partial catalytic oxidation reactor, wherein:
1) a hydrogen and carbon monoxide gas mixture is produced in said reactor through a partial catalytic oxidation reaction between at least one hydrocarbon and oxygen or a gas comprising oxygen; and
2) said reaction takes place:
i) at a temperature less than about 1200° C.; and
ii) at a pressure between about 3 bar and about 20 bar;
b) a cooling means for cooling said gas mixture, wherein:
1) said gas mixture is cooled by direct contact with pressurized water; and
2) said gas mixture is cooled to a temperature between about −20° C. and about 80° C.; and
c) a vessel, wherein said vessel comprises:
1) said reactor;
2) said cooling means; and
3) an accelerating means, wherein said accelerating means:
i) is located between said reactor and said cooling means; and
ii) accelerates the passage of said gas mixture from said reactor to said cooling means such that the gas mixture transport time between said reactor and said cooling means is less than about 100 milliseconds.

56. The apparatus of claim 55, wherein said gas mixture transport time is less than about 50 milliseconds.

57. The apparatus of claim 55, wherein said cooling means comprises a shower of pressurized water.

58. The apparatus of claim 55, further comprising a deflector means, wherein:
a) said deflector means is located downstream of said cooling means; and
b) said deflector means separates drops of water from said cooled gas mixture.

59. The apparatus of claim 55, further comprising a cooling water supply and recirculation means.

60. The apparatus of claim 59, wherein:
a) said supply and recirculation means comprises a cooling water filtration system; and
b) said filtration system filters solid particles in said gas mixture.

61. The apparatus of claim 55, wherein said acceleration means comprises an inverted cone system.
